(19) United States
(12) Patent Application Publication
(10) Pub. No.: US 2025/0080982 A1
(43) Pub. Date: Mar. 6, 2025

(54) METHOD FOR FILTERING UNAUTHENTICATED URI'S IN ELECTRONIC MESSAGES

(71) Applicant: METACERT, Inc., PLEASANTON, CA (US)

(72) Inventor: PAUL FERGUS WALSH, ALBERTA (CA)

(73) Assignee: METACERT, Inc., PLEASANTON, CA (US)

(21) Appl. No.: 18/241,869

(22) Filed: Sep. 3, 2023

(51) Int. Cl. H04W 12/106; H04W 12/06

(52) U.S. Cl. CPC H04W 12/106; H04W 12/06

(57) ABSTRACT

In certain embodiments, an incoming electronic message is screened by a local system to detect any URI's included in the message, such as a hyperlink or the text of a URI. The local system extracts the URI from the content of the message, and attempts to authenticate the URI. If the extracted URI cannot be authenticated, the URI content of the message may be replaced with a redirect to a safe webpage.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable.

### BACKGROUND OF THE INVENTION

### Field of the Invention

The present invention is related generally to security screening of electronic messages, and more particularly to a system and method for cautiously authenticating universal resource identifiers (hereinafter, “URI's”) included in electronic messages.

### Background Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

As communications technology has grown in scope and complexity, providing access to more kinds of messaging on more devices, security remains a concern. Not all computer users may be aware that, when one selects a universal resource identifier (hereinafter, “URI”) of a website or other online content, one gives permission for the server hosting the network resource identified by that URI to transmit files to the accessing computer, such as, to give a simple example, to transmit the content of a website and let the user view the website's pages. A URI might be received and selected in many ways, on a variety of devices including but not limited to computers, mobile devices, and Internet of Things devices, and by methods such as but not limited to entering an address into a browser navigation bar, clicking or tapping on a hyperlink included in a file or electronic message, downloading a file, and so on. Therefore, some common modes of scam or cyberattack include sending an electronic message which contains a uniform resource identifier (“URI”), such as in the form of a hyperlink for the recipient to click or tap on, and tricking the user into accessing the link and thus granting access to transmit files—any files the cyber-criminal may want, including viruses, malware, and worse—to the local system, to install potentially malicious software, or to gain access to sensitive personal or confidential information stored on the accessing device. At the scale of managing communications within even a medium size organization, it's impractical to rely on universal user discipline to eliminate user selections of unauthenticated links. Dependence on individual good practices alone is not sufficient or practical for protecting an entire interconnected organization against the threat of cyberattacks.

Some modes of sending and receiving, such as certain communications to Internet of Things devices, may even not require a user to be tricked into initiating access, making these implementations even more vulnerable to hacking.

Therefore, there is a long-felt need to provide a paradigm shift in internet security, including mitigation of the hazard of unsecured links.

### BRIEF SUMMARY OF THE INVENTION

Towards these and other objects of the method of the present invention (hereinafter, “the invented method”) that are made obvious to one of ordinary skill in the art in light of the present disclosure, what is provided is a system and method for screening of URI's included in electronic messages based on external validation of the URI's.

There are currently several electronic message formats used by cellular telephone networks. Short Message Service (hereinafter, “SMS”) is a cellular telephone phone protocol of, or derived from, the Global System for Mobile Communications series of standards and are used by cellular telephones and cellular telephone networks to send, transmit, and/or receive text messages over a 2G, 3G, 4G, or 5G network. Multimedia Messaging Service (hereinafter, “MMS”) is a communications technology developed by the Third Generation Partnership Project to enable the transmission of multimedia content via text messaging, e.g., electronic messages conforming to or derived from an SMS standard. Rich Communications Services (hereinafter, “RCS”) is a communications standard and protocol intended to add additional features to cellular phone messaging services, such as communicating read receipts, group messaging features, and multimedia capabilities.

In certain embodiments, an incoming or outgoing electronic message such as an SMS, MMS, or RCS communication is screened to detect any URI's included in the message, such as a hyperlink or the text of a URI. The local system extracts the URI from the content of the message, and attempts to authenticate the URI. If the extracted URI cannot be authenticated, the URI content of the message may be blocked, removed, annotated with a warning label, redirected to a different URI, or otherwise safely addressed.

It is noted that the disclosure utilizes the terms of “validation” and “authentication” as having particular and distinct definitions. In embodiments of the invention, a database has been constructed a priori containing a plurality of URI's which have been validated: tested and confirmed to be legitimate and real URI's, as opposed to scams, phishing links, traps for launching cyberattacks, or similar. In embodiments of the present invention, this database is consulted in order to authenticate a URI encountered by software implementing embodiments of the invented method, by consulting that database of previously validated and finding a match for that encountered URI (or not).

It is understood that the term “electronic message” in this disclosure might include or encompass several varieties of electronic message, such as but not limited to text messages, emails, Short Message Service (SMS) messages, Multimedia Message Service (MMS) messages, or Rich Communication Services (RCS) messages, or other communicative messages transmitted by electronic means. Different message formats may have different limitations to account for in practicing embodiments of the invented method. For instance, an SMS message format may not accommodate inclusion of a visual indicator that an included hyperlink or URI has not been authenticated, but may allow the destination of the hyperlink to be altered instead such that the user is directed to a safe alternative page. Further, it is understood that electronic messages in this expanded definition may be utilized by a variety of devices, such as but not limited to computer systems, mobile systems, augmented realities, virtual realities, and Internet of Things devices. It is further noted that several embodiments of the invented method which apply to SMS may be applicable to other messaging protocols which augment or extend SMS, such as but not limited to RCS, MMS, and the protocol used by Apple's Messages application (formerly iMessage).

Some embodiments may include or comprise a method for filtering a uniform resource identifier (“URI”) associated with an SMS message, the method implemented within an electronic communications network (“the network”), the network comprising an intermediary system and an addressee system, the method comprising: the intermediary system examining the URI associated with the SMS message (“the message”) prior to access of the message by the addressee system; the intermediary system applying an authorization logic to the URI; when the authorization logic does not authorize the URI for access, the intermediary system disabling selection by the addressee system of the URI; and transmitting the message to the addressee system.

This may further include the network comprising at least a portion of a cellular telephone wireless communications network. This may further include the addressee system comprising a cellular telephone, a network communications IoT device, and or a software enabled network communications-enabled computational device. This may further include the intermediary system delivering a caution indication in association with a disabled representation of the URI to the addressee system. This may further comprise the authorization logic including an archive of access-permitted URI's. This may further comprise the archive being located in an archive server of the network. This may further comprise the archive being distributed between at least two servers accessible via the network. This may further include at least a portion of the archive being located in a memory accessible by the intermediary system. This may further comprise the intermediary system notifying a sentinel server via the network of a receipt of the URI. This may further include the intermediary server being informed via the network that access to the URI is permitted. This may further include the intermediary server being informed that access to the URI is permitted, whereupon the intermediary server enables access to the URI by the addressee system. The method may be implemented as part of a firewall for screening data traffic. The method may be implemented by an operating system for screening local data.

Some embodiments may include or comprise a method for authenticating the safe access of a uniform resource identifier (“URI”) associated with an electronic message, the method implemented within an addressee system, the method comprising: the addressee system examining the electronic message (“the message”) prior to enabling access of the electronic message by the addressee system to a user of the addressee system; the addressee system extracting the URI from the message; the addressee system looking up the URI in an archive of URI's known to be valid; when the URI is not listed in the archive as an access-permitted URI, the addressee system disabling access to the URI in the message; and the addressee system enabling the user to read the message and without enabling access to the URI. The electronic message may be an SMS message. The method may comprise the addressee system presenting a URI caution indication in association with a rendering of the message. The method may further comprise the addressee system enabling optional access to the URI after presenting the URI caution indication. The archive may be located in an archive server of the network. The archive may be distributed between at least two servers accessible via the network. The method may further comprise the addressee system notifying a sentinel server of the URI via the network. The method may further comprise the addressee server being informed via the network that access to the URI is permitted.

Some embodiments may include or comprise a method for filtering a uniform resource identifier (“URI”) associated with an SMS message, the method implemented within an electronic communications network (“the network”), the network comprising an intermediary system and an addressee system, the method comprising: the intermediary system examining a reference URI associated with the SMS message (“the message”) prior to access of the message by the addressee system; the intermediary system applying an authorization logic to the reference URI; when the authorization logic does not authorize the reference URI for access, the intermediary system replacing the reference URI with a redirection URI, and enabling the redirection URI for selection by means of the addressee system; and transmitting the message to the addressee system with the redirection URI. The method may further comprise a disabled representation of the reference URI being transmitted to the addressee system.

Some embodiments may include or comprise a method for authenticating the safe access of a uniform resource identifier (“URI”) prior to access via a web browser, WebView, or other web content enabling user applications or devices, the method implemented within an electronic communications network (“the network”), the network comprising an intermediary system and an accessing system, the method comprising: the intermediary system handling the URI as potentially dangerous and NOT accessing the URI directly; the intermediary system looking up the URI in an archive of URI's known to be valid; and if the URI is not authenticated, the intermediary system preventing the web content access.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWING(S)

The detailed description of some embodiments of the invention is made below with reference to the accompanying figures, wherein like numerals represent corresponding parts of the figures.

FIG. 1 is a block diagram of an electronic communications network;

FIG. 2A is a block diagram of the recipient device of the network of FIG. 1;

FIG. 2B is a block diagram of the recipient local router of the network of FIG. 1;

FIG. 2C is a block diagram of the intermediary server of the network of FIG. 1;

FIG. 2D is a block diagram of the lookup database server of the network of FIG. 1;

FIG. 3A is a process chart presenting an invented method for authenticating a URI of an electronic message received via the network of FIG. 1;

FIG. 3B is a process chart regarding selection of a response to finding an unauthenticated URI, such as in the processes of FIGS. 3A and 4 through 10;

FIG. 4 is a process chart presenting an invented method for authenticating a URI of an electronic message received via the network of FIG. 1;

FIG. 5 is a block diagram chart presenting a chain of access for a recipient accessing a sent electronic message via the network of FIG. 1;

FIG. 6 is a process chart presenting an invented method for authenticating URIs shared in a group messaging context via the network of FIG. 1;

FIG. 7 is a process chart presenting an invented method for authenticating URIs in the context of a web browser accessing the internet via the network of FIG. 1;

FIG. 8 is a process chart presenting an invented method for authenticating URIs in the context of a firewall monitoring the traffic of the network of FIG. 1;

FIG. 9 is a process chart presenting an invented method for authenticating URIs in the context of an operating system running on one or more of the devices of the network of FIG. 1;

FIG. 10 is a process chart presenting an invented method for authenticating URIs in the context of an application programming interface implementation for one or more devices of the network of FIG. 1;

FIG. 11 is a process chart presenting an invented method for authenticating URIs in the context of receiving an SMS via the network of FIG. 1;

FIG. 12 is a process chart presenting an invented method for authenticating URIs in the context of transmitting an SMS via the network of FIG. 1;

FIG. 13 is a process chart regarding selection of a response to finding an unauthenticated URI in an outbound message, such as in the processes of FIG. 12; and

FIG. 14 is a graphical representation of an SMS message as sent in the process of FIG. 11.

### DETAILED DESCRIPTION OF THE INVENTION

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the range's limits, an excluding of either or both of those included limits is also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Additionally, it should be understood that any transaction or interaction described as occurring between multiple computers is not limited to multiple distinct hardware platforms, and could all be happening on the same computer. It is understood in the art that a single hardware platform may host multiple distinct and separate server functions.

Throughout this specification, like reference numbers signify the same elements throughout the description of the figures.

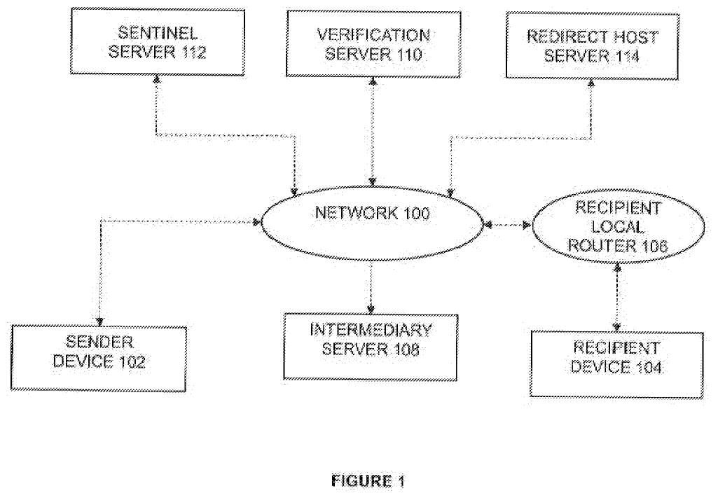

Referring now generally to the Figures and particularly to FIG. 1, FIG. 1 is a block diagram of an electronic communications network 100 (“the network 100”) which connects a plurality of computing devices; the network 100 might be the internet, a local area network, a cellular network, or any other kind of electronic communications network. Some of the computing devices which might be connected to the network 100 and might be relevant to practice of embodiments of the invented method are depicted here as boxes of the diagram. These might include, and are not limited to, a sender device 102 from which an electronic message is sent or posted; a recipient device 104 accessible by a recipient to which a sent electronic message is directed; a recipient local router 106 which may be interposed between the recipient device 104 and the rest of the network 100 and include potentially relevant security features such as a firewall; an intermediary server 108 which might receive electronic messages on behalf of the recipient and subsequently transmit onward, or be accessed to retrieve, the received messages; a validation server 110 which may provide utilities for use in practicing embodiments of the invented method; a sentinel server 112 which may be notified of unauthenticated URI's; and a redirect host server 114 which may host a safe URI redirect page as described in certain embodiments of the invented method.

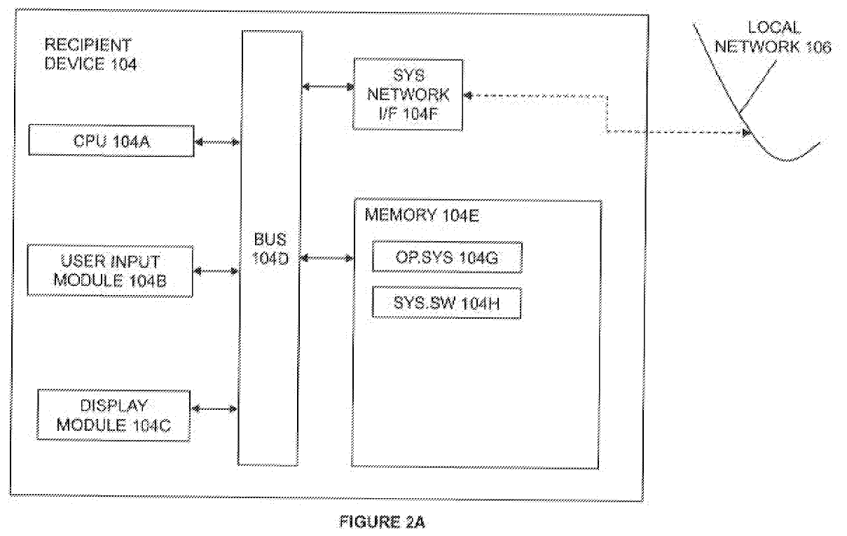

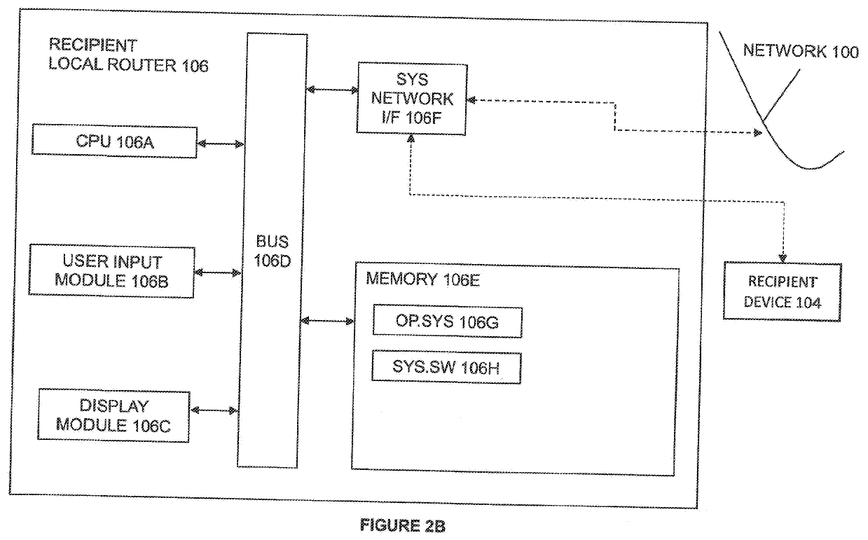

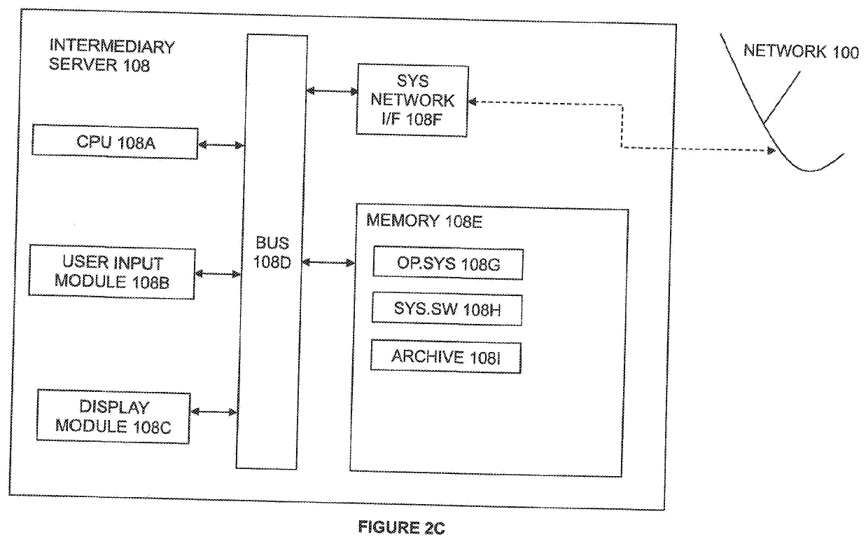

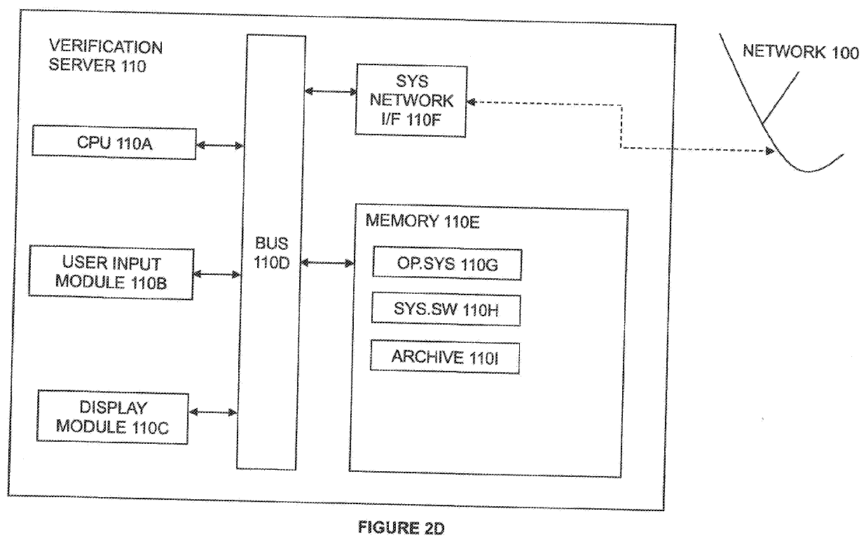

Referring now generally to the Figures, and particularly to FIG. 2A, FIG. 2A is a block diagram of the recipient device 104 of the electronic communications network 100 of FIG. 1 and displaying together both hardware and software aspects thereof, wherein the recipient device 104 comprises: a central processing unit or “CPU” 104A; a user input module 104B; a display module 104C; a software bus 104D bi-directionally communicatively coupled with the CPU 104A, the user input module 104B, the display module 104C; the software bus 104D is further bi-directionally coupled with a network interface 104E, enabling communication with alternate computing devices by means of the network 100; and a memory 104F. The software bus 104D facilitates communications between the above-mentioned components of the recipient device 104. The memory 104F of the recipient device 104 includes a software operating system (OS) OP.SYS 104G. The recipient device 104 may be selected from freely available, open source and/or commercially available computational equipment, to include but not limited to a.) a Z8 G4 computer workstation marketed by Hewlett Packard Enterprise of San Jose, California and running a Red Hat Linux™ OS marketed by Red Hat, Inc. of Raleigh, North Carolina; (b.) a Dell Precision™ computer workstation marketed by Dell Corporation of Round Rock, Texas, and running a Windows™ 10 OS marketed by Microsoft Corporation of Redmond, Wash.; (c.) a Mac Pro workstation running MacOS X™ as marketed by Apple, Inc. of Cupertino, Calif; (d.) an Internet of Things device such as but not limited to an Apple Watch SE as marketed by Apple, Inc. of Cupertino, Calif; or (e.) other suitable computational system or electronic communications device known in the art capable of providing networking and OS services as known in the art. The OS software OP.SYS 104G may be or comprise computational OS software as referenced within this disclosure, and/or other suitable OS systems known in the art. The exemplary software program SW.SRC 104H consisting of executable instructions and associated data structures is optionally adapted to enable the recipient device 104 to perform, execute and instantiate all elements, aspects and steps as required of the recipient device 104 to practice the invented method in its various preferred embodiments in interaction with other devices of the network 100.

Referring now generally to the Figures, and particularly to FIG. 2B, FIG. 2B is a block diagram of the recipient local router 106 of the electronic communications network 100 of FIG. 1 and displaying together both hardware and software aspects thereof, wherein the recipient local router 106 comprises: a central processing unit or “CPU” 106A; a user input module 106B; a display module 106C; a software bus 106D bi-directionally communicatively coupled with the CPU 106A, the user input module 106B, the display module 106C; the software bus 106D is further bi-directionally coupled with a network interface 106E, enabling communication with alternate computing devices by means of the network 100; and a memory 106F. The software bus 106D facilitates communications between the above-mentioned components of the recipient local router 106. The memory 106F of the recipient local router 106 includes a software OS OP.SYS 106G. The recipient local router 106 may be selected from freely available, open source and/or commercially available computational equipment, to include but not limited to a.) an Asus ROG Strix GS-AX5400 as marketed by ASUSTeK Computer Inc. of Beitou District, Taipei, Taiwan; (b.) a Linksys Hydra Pro AXE6600 Wi-Fi 6E Tri-Band Router as marketed by Linksys of Irvine, CA; (c.) a NETGEAR AX1800 Wi-Fi 6 Router as marketed by NETGEAR, Inc. of San Jose, CA; or (d.) other suitable router computational system or electronic communications device known in the art capable of providing networking and OS services as known in the art. The OS software OP.SYS 106G may be or comprise computational OS software as referenced within this disclosure, and/or other suitable OS systems known in the art. The exemplary software program SW.SRC 106H consisting of executable instructions and associated data structures is optionally adapted to enable the recipient local router 106 to perform, execute and instantiate all elements, aspects and steps as required of the recipient local router 106 to practice the invented method in its various preferred embodiments in interaction with other devices of the network 100.

Referring now generally to the Figures, and particularly to FIG. 2C, FIG. 2C is a block diagram of the intermediary server 108 of the electronic communications network 100 of FIG. 1 and displaying together both hardware and software aspects thereof, wherein the intermediary server 108 comprises: a central processing unit or “CPU” 108A; a user input module 108B; a display module 108C; a software bus 108D bi-directionally communicatively coupled with the CPU 108A, the user input module 108B, the display module 108C; the software bus 108D is further bi-directionally coupled with a network interface 108E, enabling communication with alternate computing devices by means of the network 100; and a memory 108F. The software bus 108D facilitates communications between the above-mentioned components of the intermediary server 108. The memory 108F of the intermediary server 108 includes a software OS OP.SYS 108G. The intermediary server 108 may be selected from freely available, open source and/or commercially available computational equipment, to include but not limited to a.) a Z8 G4 computer workstation marketed by Hewlett Packard Enterprise of San Jose, California and running a Red Hat Linux™ OS marketed by Red Hat, Inc. of Raleigh, North Carolina; (b.) a Dell Precision™ computer workstation marketed by Dell Corporation of Round Rock, Texas, and running a Windows™ 10 OS marketed by Microsoft Corporation of Redmond, Wash.; (c.) a Mac Pro workstation running MacOS X™ as marketed by Apple, Inc. of Cupertino, Calif; (d.) an Internet of Things device such as but not limited to an Apple Watch SE as marketed by Apple, Inc. of Cupertino, Calif; or (e.) other suitable computational system or electronic communications device known in the art capable of providing networking and OS services as known in the art. The OS software OP.SYS 108G may be or comprise computational OS software as referenced within this disclosure, and/or other suitable OS systems known in the art.

The exemplary software program SW.SRC 108H consisting of executable instructions and associated data structures is optionally adapted to enable the intermediary server 108 to perform, execute and instantiate all elements, aspects and steps as required of the intermediary server 108 to practice the invented method in its various preferred embodiments in interaction with other devices of the network 100. The memory 108F of the intermediary server 108 may further include an archive 1081 containing URI's validated as safe to access.

Referring now generally to the Figures, and particularly to FIG. 2D, FIG. 2D is a block diagram of the lookup database server 110 of the electronic communications network 100 of FIG. 1 and displaying together both hardware and software aspects thereof, wherein the lookup database server 110 comprises: a central processing unit or “CPU” 110A; a user input module 110B; a display module 110C; a software bus 110D bi-directionally communicatively coupled with the CPU 110A, the user input module 110B, the display module 110C; the software bus 110D is further bi-directionally coupled with a network interface 110E, enabling communication with alternate computing devices by means of the network 100; and a memory 110F. The software bus 110D facilitates communications between the above-mentioned components of the lookup database server 110. The memory 110F of the lookup database server 110 includes a software OS OP.SYS 110G. The lookup database server 110 may be selected from freely available, open source and/or commercially available computational equipment, to include but not limited to a.) a Z8 G4 computer workstation marketed by Hewlett Packard Enterprise of San Jose, California and running a Red Hat Linux™ OS marketed by Red Hat, Inc. of Raleigh, North Carolina; (b.) a Dell Precision™ computer workstation marketed by Dell Corporation of Round Rock, Texas, and running a Windows™ 10 OS marketed by Microsoft Corporation of Redmond, Wash.; (c.) a Mac Pro workstation running MacOS X™ as marketed by Apple, Inc. of Cupertino, Calif.; (d.) an Internet of Things device such as but not limited to an Apple Watch SE as marketed by Apple, Inc. of Cupertino, Calif.; or (e.) other suitable computational system or electronic communications device known in the art capable of providing networking and OS services as known in the art. The OS software OP. SYS 110G may be or comprise computational OS software as referenced within this disclosure, and/or other suitable OS systems known in the art. The exemplary software program SW.SRC 110H consisting of executable instructions and associated data structures is optionally adapted to enable the lookup database server 110 to perform, execute and instantiate all elements, aspects and steps as required of the lookup database server 110 to practice the invented method in its various preferred embodiments in interaction with other devices of the network 100. The memory 110F of the validation server 110 may further include an archive 1101 containing URI's validated as safe to access.

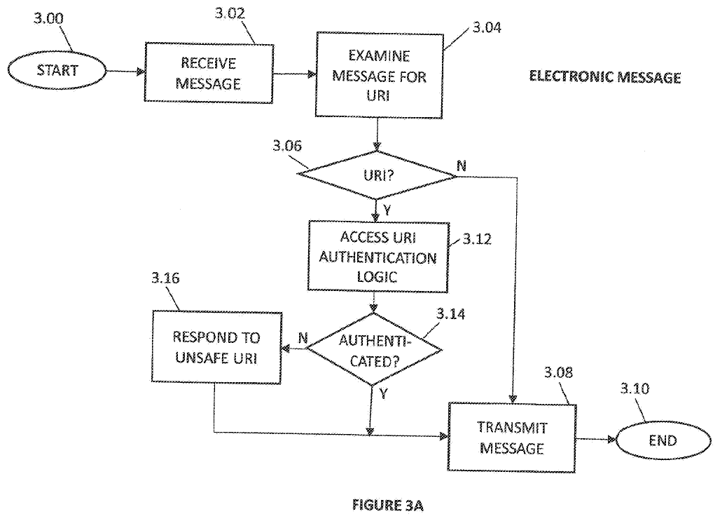

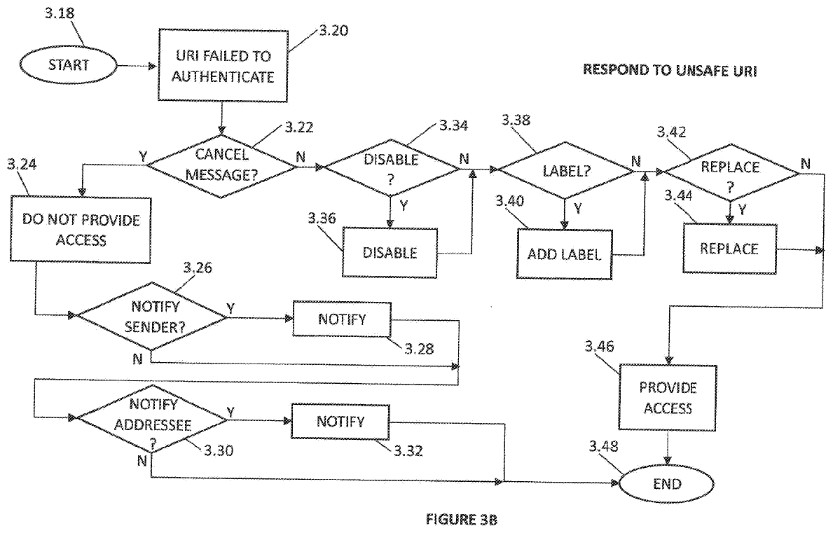

Referring now generally to the Figures and particularly to FIG. 3A, FIG. 3A is a process chart presenting an invented method for authenticating a URI of an electronic message received via the network 100. It is noted that this general overview process might be practiced on any kind of electronic message by any relevant system which may screen messages. At step 3.00, the process begins. At step 3.02, an electronic message is received. At step 3.04, the received electronic message is examined for a URI. At step 3.06, any URI detected in the electronic message contents—such as a hyperlink or URI text—is extracted from the electronic message; if there is no URI to extract, then at step 3.08, the received electronic message is transmitted onward and the process ends at step 3.10. Otherwise, at step 3.12, authentication of the URI is attempted. At step 3.14, if the authentication was successful, the message is transmitted onward; otherwise, at step 3.16 the unauthenticated URI is responded to, such as with one of the options presented in FIG. 3B.

Referring now generally to the Figures and particularly to FIG. 3B, FIG. 3B is a process chart for selecting a response to a detected unauthenticated URI. At step 3.18, the process starts. As of step 3.20, a URI has failed to authenticate; this process chart is a decision process of what to do when that happens. It is understood that a system practicing an embodiment of the invented method might have one of the presented options already selected and coded in, or alternatively might be adapted to select among multiple of these depending on the details of the situation. At step 3.22, it is determined whether to cancel the message, i.e. not deliver the electronic message in which the unauthenticated URI is included at all, including any contents besides the URI itself. At step 3.24, if this option is selected, access to the electronic message is not provided to the addressee. At step 3.26, an option is provided to notify the sender that the message was not delivered; this option might be preferred in the context of a group chat: if a sender tries to post something that gets “bounced”, that sender may be advised, without anyone else seeing the message, that what the sender tried to post isn't permitted. If the option of notifying the sender is selected, at step 3.28 the sender is notified. Regardless, an option may also be provided at step 3.30 to notify the addressee, such as a notification by one's email service, messaging application, or other software that a message from this sender was blocked for this reason; if the addressee knows the sender or was expecting this communication, the addressee might then be able to contact the sender some other way to follow up or, if the option is available, unblock the message despite the unauthenticated URI. If the addressee is to be notified, this occurs at step 3.32. Alternatively, if the message is not cancelled at step 3.22, then at step 3.34, it is determined whether to disable the unauthenticated URI, such as by converting a hyperlink to plain text, or altering the content of the URI. If this option is selected, at step 3.36 the URI is disabled. At step 3.38, it is determined whether to label the instance of an unauthenticated URI, such as with a warning label stating that this URI could not be authenticated and was disabled, or may not be safe to access. It is noted that not all media of electronic messages permit alteration of electronic messages in this way, but for those that do, this may be preferred as an option to inform an addressee that the URI has been altered for security reasons, or that the URI has not been altered but has been flagged as unauthenticated. If this option is selected, the label is applied at step 3.40. At step 3.42, it is determined whether to replace the URI entirely, such as with a different URI leading to a safe landing page instead; in some electronic messaging media, this option is available for even if the message cannot be altered otherwise. If this option is selected, then at step 3.44, the URI is replaced. Once the message has been modified in accordance with steps 3.34 through 3.44, then the modified message is delivered or made accessible to the addressee at step 3.46. Regardless of which options were selected, the process ends at step 3.48 with either the message (as modified), a notification about the message, or no message having been delivered.

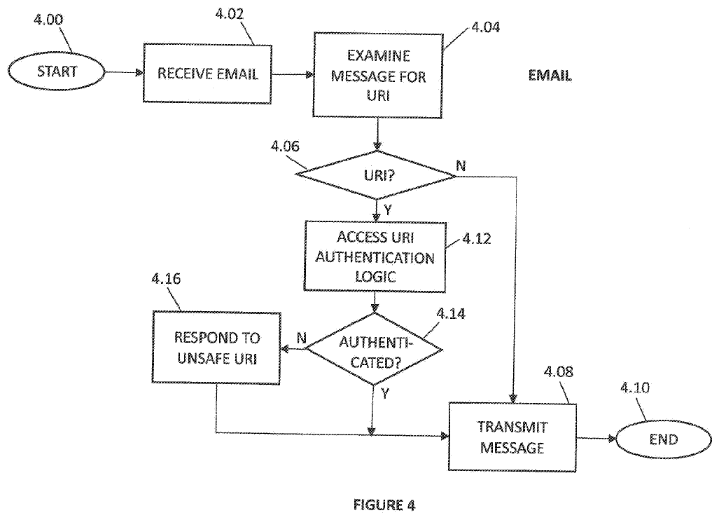

Referring now generally to the Figures and particularly to FIG. 4, FIG. 4 is a process chart presenting an invented method for authenticating a URI of an email received via the network 100. At step 4.00, the process starts. At step 4.02, an email is received. At step 3.04, the received electronic message is examined for a URI. At step 4.06, any URI detected in the email contents—such as a hyperlink or URI text—is extracted from the email; if there is no URI to extract, then at step 4.08, the received email is transmitted onward and the process ends at step 4.10. Otherwise, at step 4.12, authentication of the URI is attempted. At step 4.14, if the authentication was successful, the email is transmitted onward; otherwise, at step 4.16 the unauthenticated URI is responded to, such as with one of the options presented in FIG. 3B.

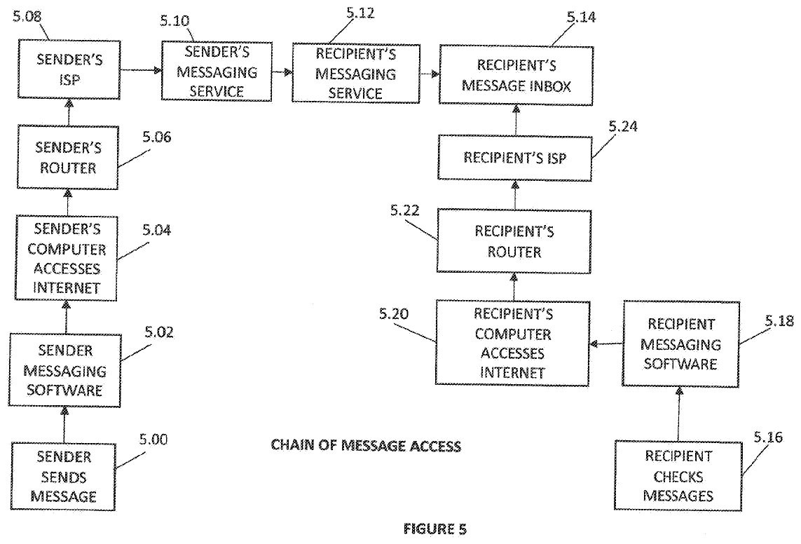

Referring now generally to the Figures and particularly to FIG. 5, FIG. 5 is a block diagram chart presenting a chain of access for a sender sending and a recipient accessing a sent electronic message. While other diagrams present hardware and software environments, the main intention with this diagram is to present a series of several points at which, throughout the process of sending and receiving a message, that message might be screened for security concerns such as an unauthenticated URI. Box 5.00 is a representation of the sender sending the message. Box 5.02 represents the message being entered into and sent via a messaging software application the sender may operate on the sender device 102 in order to send the message, such as but not limited to an email client like Microsoft Outlook or Mozilla Thunderbird, a messaging or chat application such as WhatsApp or Discord, and so on. The software application being operated by the sender might screen for an unauthenticated URI the same way the application might offer spelling corrections or autofills; if the sender is not intending to send a suspicious URI that could be flagged as dangerous or get blocked and not reach the recipient, it's possible the sender would want to be informed so this error can be fixed prior to sending. Once the message is sent, at box 5.04, the sender device 102 transmits the message from the sender device 102 over the network 100. At box 5.06, the message passes through a router managing the sender's local area network; this router, whether a router owned by the sender or a router providing a source of business or public WiFi to which the sender device 102 may be connected, might be set up to provide a firewall or other security checking, which might usefully include screening of URIs in data traffic passing through. This router is connected to the internet as a whole by an internet service provider at box 5.08, which provider could also include security screening if it prefers, such as screening of URIs. At box 5.10, the message may pass through servers belonging to their messaging service, such as an email server or a server belonging to a particular messaging service, which can direct the message to the messaging account, email address, or similar belonging to the addressed recipient of the message; this server may also include screening such as URI screening. At box 5.12, the message is received by a server providing messaging services to the recipient; this may be the same messaging service, or a different compatible one, and that service may also implement message screening as preferred. That service would receive the message, and direct the message to be listed in an inbox belonging to the recipient at box 5.14.

From the other side, at box 5.16, the recipient initiates access to the message by checking their messages. The recipient may check their messages through a local message client application at box 5.18 on the recipient device 104, which program may have accessed the email server inbox of box 5.14 on the recipient's behalf to present the recipient's inbox on the recipient device 104, or the recipient may access the inbox through means such as a browser window. Either way, this is an instance of accessing the network 100, represented by box 5.20. The recipient's internet access passes through the recipient local router 106 at box 5.22 and the recipient's internet service provider at box 5.24, to reach the recipient's inbox. The recipient's messaging software, network connection settings, router, or internet service provider may, likewise, each optionally implement security screening of incoming or outgoing traffic such as any URIs contained in the message being accessed by the recipient.

Every box represented in this chain is noted as a point at which security screening such as URI authentication in accordance with embodiments of the invented method, might potentially be implemented; it is noted that these are presented as examples of potential checkpoints, and not as a comprehensive or exhaustive list or limitation of scope. The message server of box 5.12 might implement such security for all of the inboxes hosted there, or as an option the recipient can enable for the recipient's inbox particularly; as a non-limiting example of this kind of model, most email inbox services currently provide spam filtering as part of the service. The recipient's internet service provider might provide security screening of incoming data packets, or the recipient might install or enable such security on the recipient local router 106 as additional firewall protection. The OS OP. SYS 104G of the recipient device 104 might implement security screening of incoming data or all data. The local message client program may screen all messages downloaded from the message server prior to showing the newly received emails to the recipient. Security filtering such as various embodiments of the invented method might be implemented at any of these points in this represented chain of access, or even at more than one. It is further noted that screening might be implemented as a security feature (i.e. to filter potential hazards out of incoming traffic), as a pre-emptive composition aid (i.e. to caution a sender against trying to send something that might register as suspicious to a recipient's message filtering), or as a mode of moderating network traffic overall, such as a host of a public WiFi network, an internet service provider, or messaging service taking steps against circulation of suspicious or unsecured content via the network or platform that entity maintains.

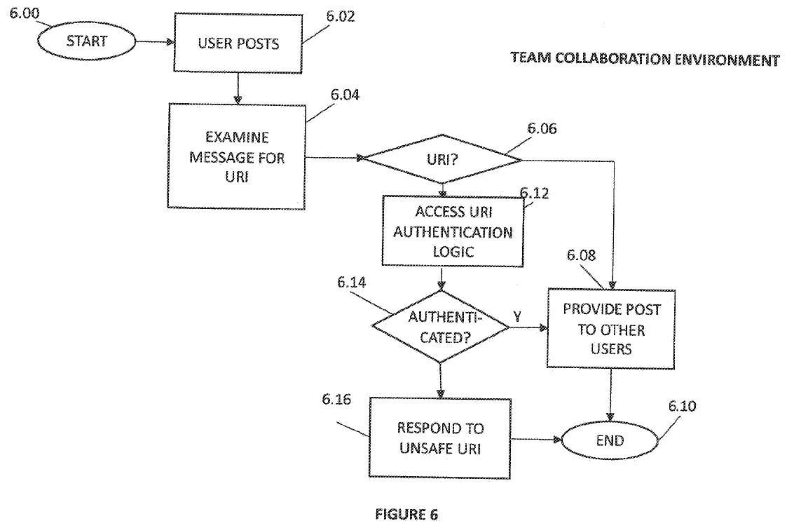

Referring now generally to the Figures and particularly to FIG. 6, FIG. 6 is a process chart presenting an invented method for authenticating URIs shared in a group messaging context via the network 100. At step 6.00, the process starts. At step 6.02, a user posts. At step 6.04, the posted electronic message is examined for a URI. At step 6.06, any URI detected in the post contents—such as a hyperlink or URI text—is extracted from the post; if there is no URI to extract, then at step 6.08, the post is made available to the other users and the process ends at step 6.10. Otherwise, at step 6.12, authentication of the URI is attempted. At step 6.14, if the authentication was successful, the post is posted; otherwise, at step 6.16 the unauthenticated URI is responded to, such as with one of the options presented in FIG. 3B.

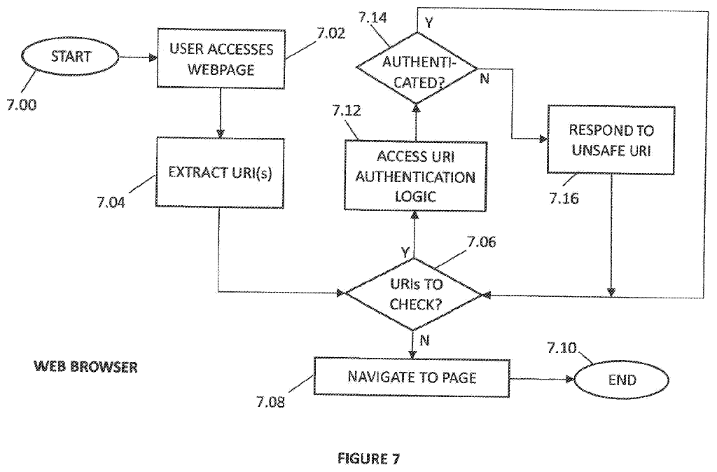

Referring now generally to the Figures and particularly to FIG. 7, FIG. 7 is a process chart presenting an invented method for authenticating URIs in the context of a web browser accessing the internet via the network 100. At step 7.00, the process starts. At step 7.02, a human user accesses a webpage. At step 7.04, any URI's present on the webpage—such as but not limited to links to other webpages or URI text—are extracted. There may be one, none, or multiple URI's to screen; a loop is included in this process chart to account for this, and it is understood that other process charts included herein might likewise usefully include loops, be practiced multiple times for multiple URIs, or skip steps if no URIs are found to be present, and representation of certain specific embodiments as examples does not exclude by omission other possible embodiments in accordance with the claims. At step 7.06, it is determined whether there are URIs to be screened; if there are none, the page is loaded at step 7.08, and the process ends at step 7.10. Otherwise, at step 7.12, authentication of the URI is attempted. At step 7.14, it is determined whether the authentication was successful; if not, then at step 7.16, the un-authenticated URI is responded to, such as with one of the options of FIG. 3B.

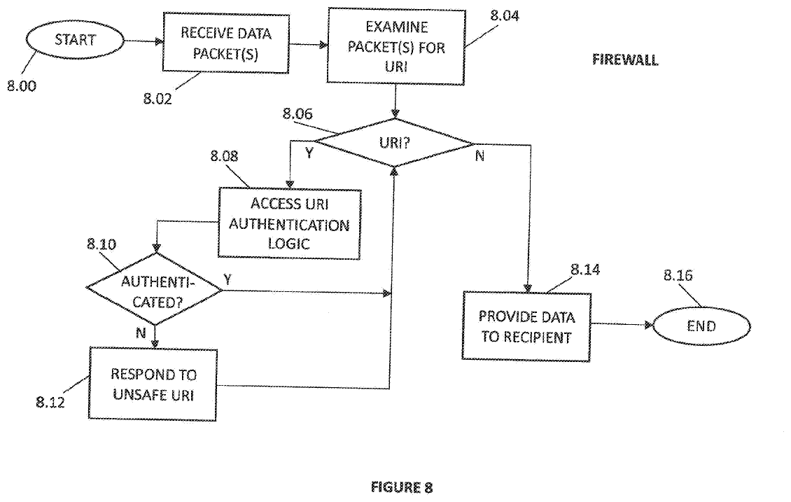

Referring now generally to the Figures and particularly to FIG. 8, FIG. 8 is a process chart presenting an invented method for authenticating URIs in the context of a firewall monitoring the traffic of the network 100, such as a firewall maintained by the recipient local router 106. At step 8.00, the process starts. At step 8.02, one or more data packets is received. At step 8.04, the received data packet(s) are examined for URIs. At step 8.06, it is determined whether the data packets contain URI's requiring authentication; it is noted that this step of the chart is utilized both as a determination of whether any URI's are present at all, and also as a loop logic condition for handling multiple URI's being received at once. If there are URI's to authenticate, then at step 8.08, authentication of the URI is attempted. At step 8.10, it is determined whether the authentication was successful; if not, the unauthenticated URI is responded to at step 8.12, such as with one or more of the options presented in FIG. 3B. Once all of the URI's present in the data packet(s) have been either authenticated or responded to, at step 8.14, the data packet(s), potentially modified in response to unauthenticated URIs, are permitted to pass through the firewall and directed toward the appropriate destination, such as the recipient device 104. At step 8.16, the process ends.

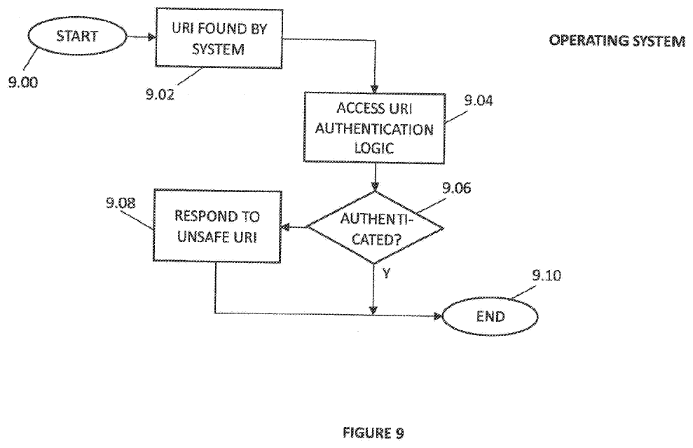

Referring now generally to the Figures and particularly to FIG. 9, FIG. 9 is a process chart presenting an invented method for authenticating URIs in the context of an operating system (OS) running on one or more of the devices of the network 100. At step 9.00, the process starts. At step 9.02, the OS finds a URI, such as in a downloaded file or received message. It is noted that multiple URIs might be found by the OS and this process might be performed multiple times, but one iteration concerning a single URI is presented for example. At step 9.04, authentication of the URI is attempted. At step 9.06, it is determined whether the authentication was successful; if not, the unauthenticated URI is responded to at step 9.08, such as with one or more of the options presented in FIG. 3B. Once the URI found by the OS has been either successfully authenticated or responded to appropriately if authentication was unsuccessful, the process ends at step 9.10. It is noted, as some non-limiting examples regarding implementation of this kind of embodiment, that this kind of security checking could be implemented as a task performed by the OS automatically with any newly loaded file, might be included as part of opening a file (or more specifically part of opening a file that hasn't been opened before), or might run periodically as a background process to ensure continued device security.

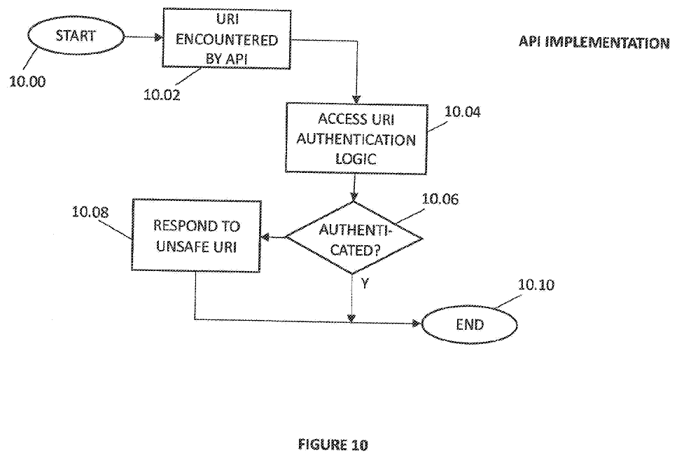

Referring now generally to the Figures and particularly to FIG. 10, FIG. 10 is a process chart presenting an invented method for authenticating URIs in the context of an application programming interface (API) implementation for one or more devices 104-112 of the network 100. At step 10.00, the process starts. At step 10.02, the software implementing the API encounters a URI received via the network 100 or otherwise accessible at least one device 104-112 (hereinafter, “the authentication system” 104-112). At step 10.04 the authentication system 104-112) attempts authentication of the URI via the network 100 and at least one other device 104-112. At step 10.06, when the authentication system 104-112 determines whether the authentication of step 10.04 was successful, the authentication system 104-112 enables the URI to be further accessed and/or transmitted. In the alternative, when the authentication system 104-112 etermines in step 10.06 that the URI is not authenticated, the receipt or detection of the unauthenticated URI is responded to by the authentication system 104-112 at step 10.08, such as with one or more of the options presented in FIG. 3B. Once the URI examined in step 10.04 by the authentication system 104-112 has been either successfully authenticated or responded to appropriately if authentication was unsuccessful, the process ends at step 10.10.

As a non-limiting example, some possible lines of code are provided here for potential inclusion in an API implementation such as that of FIG. 10:

```
API Request:
{
      curl --location ′https://authentication-api.metacert.com/v1/check′ \
      --header ′Content-Type: application/json′ \
      --header ′security-token: TOKEN′ \
      --header ′api-key: SECKEY′ \
      --data ′{
        ″uri″: ″metacert.com″
}
API Response for Authenticated URI:
{
  ″uri″: ″https://metacert.com″,
  ″status″: ″authenticated″
}
API Response for Unauthenticated URI:
{
  ″uri″: ″https://example.org″,
  ″status″: ″unauthenticated″,
  ″mcUri″: ″https://mct.link/0.fgh598jaaicja″
}
```

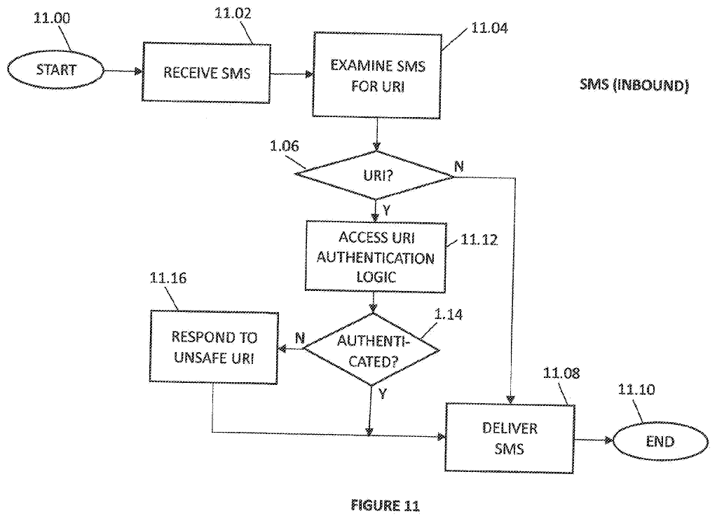

Referring now generally to the Figures and particularly to FIG. 11, FIG. 11 is a process chart presenting an invented method for authenticating URIs in the context of receiving an SMS message via the network 100. At step 11.00, the process begins. At step 11.02, an electronic message is received. At step 11.04, the received electronic message is examined for a URI. At step 11.06, any URI detected in the electronic message contents—such as a hyperlink or URI text—is extracted from the electronic message; if there is no URI to extract, then at step 11.08, the received electronic message is transmitted onward and the process ends at step 11.10. Otherwise, at step 11.12, authentication of the URI is attempted. At step 11.14, if the authentication was successful, the message is transmitted onward; otherwise, at step 11.16 the unauthenticated URI is responded to, such as with one of the options presented in FIG. 3B.

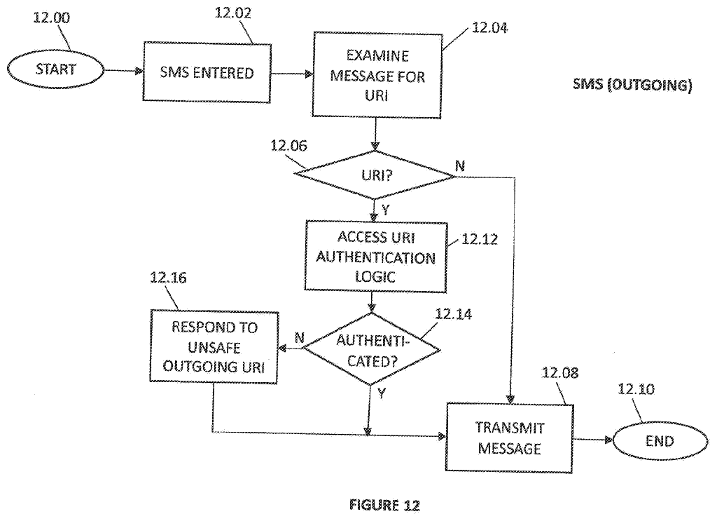

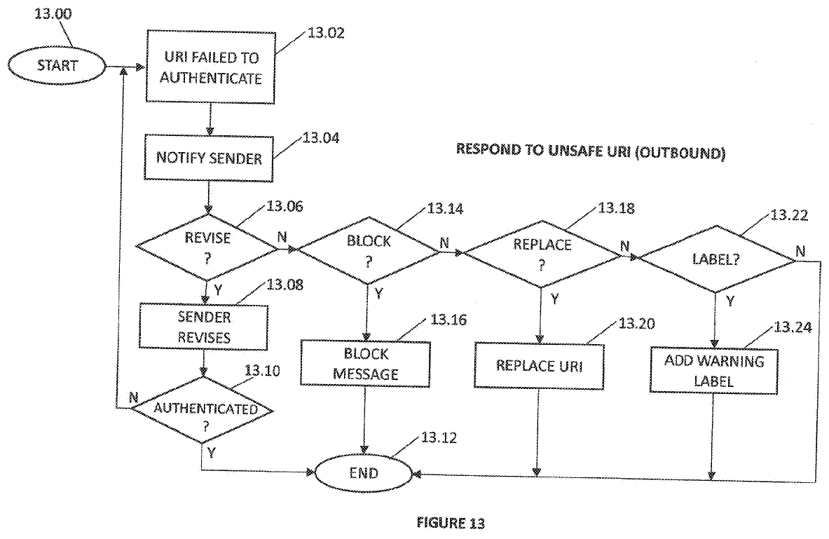

Referring now generally to the Figures and particularly to FIG. 12, FIG. 12 is a process chart presenting an invented method for authenticating URIs in the context of transmitting an SMS via the network 100. At step 12.00, the process begins. At step 12.02, a message is entered by a sender. At step 12.04, the received electronic message is examined for a URI. At step 12.06, any URI detected in the electronic message contents—such as a hyperlink or URI text—is extracted from the electronic message; if there is no URI to extract, then at step 12.08, the received electronic message is transmitted onward and the process ends at step 12.10. Otherwise, at step 12.12, authentication of the URI is attempted. At step 12.14, if the authentication was successful, the message is transmitted; otherwise, at step 12.16 the unauthenticated URI is responded to, such as with one of the options presented in FIG. 13.

Referring now generally to the Figures and particularly to FIG. 13, FIG. 13 is a process chart regarding selection of a response to finding an unauthenticated URI in an outbound SMS message. At step 13.00, the process starts. At step 13.02, an attempt has been made to authenticate a URI contained in an outgoing SMS message being composed or sent, and that authentication has failed. At step 13.04, the sender of the message is notified that the authentication failed. At step 13.06, the sender is given the option to revise the message; for instance, the failure to authenticate may have resulted from a typo by the sender in composing the message. It's also possible that, for whatever reason, the correct URI the sender would like to enclose is not listed in the database being used to authenticate, for whatever reason; the sender may prefer to select a different URI rather than risk having the message bounced or flagged as suspicious, or may prefer to omit the URI from the message. At step 13.08, the sender revises the message. At step 13.10, the authentication check is repeated. If authentication is successful this time, the failure to authenticate has been successfully resolved and the process ends at step 13.12.

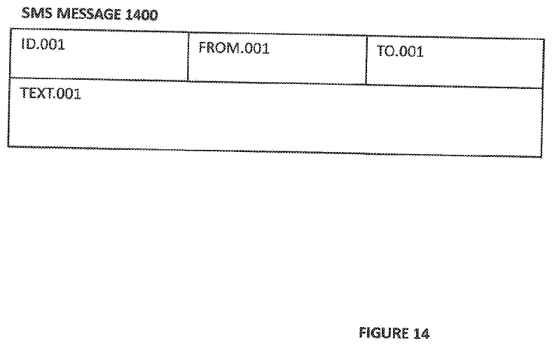

Referring now generally to the Figures and particularly to FIG. 14, FIG. 14 is a block diagram representing an SMS message 1400. The SMS message 1400 may preferably include at least a unique identifier ID.001 for identifiable storage within a messaging system; a sender identifier FROM.001, a recipient identifier TO.001, and a text body TEXT.001. Any URI's included in the SMS would be included as part of the text of the text body TEXT.001.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. A method for filtering a uniform resource identifier (“URI”) associated with an SMS message, the method implemented within an electronic communications network (“the network”), the network comprising an intermediary system and an addressee system, the method comprising:
the intermediary system examining the URI associated with the SMS message (“the message”) prior to access of the message by the addressee system;
the intermediary system applying an authorization logic to the URI;
when the authorization logic does not authorize the URI for access, the intermediary system disabling selection by the addressee system of the URI; and
transmitting the message to the addressee system.

2. The method of claim 1, wherein the network comprises at least a portion of a cellular telephone wireless communications network.

3. The method of claim 2, wherein the addressee system comprises a cellular telephone.

4. The method of claim 1, further comprising the intermediary system delivering a caution indication in association with a disabled representation of the URI to the addressee system.

5. The method of claim 1, wherein the authorization logic includes an archive of access-permitted URI'S.

6. The method of claim 1, wherein the archive is located in an archive server of the network.

7. The method of claim 6, wherein at least a portion of the archive is located in a memory accessible by the intermediary system.

8. The method of claim 1, further comprising the intermediary system notifying a sentinel server via the network of a receipt of the URI.

9. The method of claim 8, wherein the intermediary server is informed via the network that access to the URI is permitted.

10. The method of claim 9, wherein the intermediary server is informed that access to the URI is permitted, whereupon the intermediary server enables access to the URI by the addressee system.

11. The method of claim 10, further comprising modifying the text to visually indicate that the URI is enabled for access.

12. The method of claim 10, further comprising modifying the text by replacing the URI with a visually branded URI that enables access to the resource pointed to by the URI, wherein the system indicates that the visually branded URI is enabled for access and approved for use.

13. A method for authenticating the safe access of a uniform resource identifier (“URI”) associated with an SMS message, the method implemented within an addressee system, the method comprising:
the addressee system examining the SMS message (“the message”) prior to enabling access of the message by the addressee system to a user of the addressee system;
the addressee system extracting the URI from the message;
the addressee system looking up the URI in an archive of URI's known to have been previously validated;
when the URI is not listed in the archive as an access-permitted URI, the addressee system disabling access to the URI in the message; and
the addressee system enabling the user to read the message and without enabling access to the URI.

14. The method of claim 13, further comprising the addressee system presenting a URI caution indication in association with a rendering of the message.

15. The method of claim 14, further comprising the addressee system enabling optional access to the URI after presenting the URI caution indication.

16. The method of claim 10, wherein the archive is located in an archive server of the network.

17. The method of claim 10, further comprising the addressee system notifying a sentinel server of the URI via the network.

18. The method of claim 17, wherein the addressee server is informed via the network that access to the URI is permitted.

19. The method of claim 1, implemented as part of a firewall for screening data traffic.

20. The method of claim 1, implemented by an operating system for screening local data.

21. A method for filtering a uniform resource identifier (“URI”) associated with an SMS message, the method implemented within an electronic communications network (“the network”), the network comprising an intermediary system and an addressee system, the method comprising:
the intermediary system examining a reference URI associated with the SMS message (“the message”) prior to access of the message by the addressee system;
the intermediary system applying an authorization logic to the reference URI;
when the authorization logic does not authorize the reference URI for access, the intermediary system replacing the reference URI with a redirection URI, and enabling the redirection URI for selection by means of the addressee system; and
transmitting the message to the addressee system with the redirection URI.

22. The method of claim 21, wherein a disabled representation of the reference URI is transmitted to the addressee system.

23. A method for authenticating the safe access of a uniform resource identifier (“URI”) included in an SMS message prior to access, the method implemented within an electronic communications network (“the network”), the network comprising an intermediary system and an accessing system, the method comprising:
the intermediary system looking up the URI in an archive of URI's known to be valid; and
if the URI is not present in the archive, the intermediary system preventing the access.
